(19) United States
(12) Patent Application Publication
(10) Pub. No.: US 2012/0188469 A1
(43) Pub. Date: Jul. 26, 2012

(54) PROJECTOR

(75) Inventor: Kosuke Fukui, Chino-shi (JP)

(73) Assignee: Seiko Epson Corporation, Tokyo (JP)

(21) Appl. No.: 13/341,407

(22) Filed: Dec. 30, 2011

(30) Foreign Application Priority Data
Jan. 25, 2011 (JP) 2011-012831

(51) Int. Cl. G02F 1/1335

(52) U.S. Cl. 349/5

(57) ABSTRACT

A projector according to the invention includes: a plurality of illumination systems, each of which is configured so as to include a solid-state light source, that emit light of different wavelengths; a liquid-crystal panel that modulates the light emitted from the plurality of illumination systems; wavelength plates, provided one-to-one for the respective illumination systems in the respective optical paths between each of the plurality of illumination systems and the liquid-crystal panel, whose retardations are set to ¼ the central wavelength of the light emitted from the corresponding illumination systems; and a projection optical system that projects the light modulated by the liquid-crystal panel.

### BACKGROUND

1. Technical Field

The present invention relates to projectors.

2. Related Art

Projectors capable of enlarging and projecting an image formed using a liquid-crystal panel have been known for some time. Generally speaking, a liquid-crystal panel within a projector has smaller pixels than the pixels present in a direct-view liquid-crystal display device, and thus it is easy for orientation problems, in which the liquid-crystal particles fall toward a different direction than the intended direction due to potential differences or the like between adjacent pixels, to occur. As a result, there are cases where display problems occur in images projected by the projector.

Although a pre-tilt angle relative to the thickness direction of a liquid-crystal layer may be increased in order to reduce such orientation problems in the liquid-crystals, such a method is likely to cause a drop in the contrast ratio. Furthermore, in the case where an inorganic orientation layer is employed in order to increase the light resistance, it is difficult to form such an inorganic orientation layer in a manner that enables a high pre-tilt angle to be realized.

In response to the aforementioned past technique, in JP-A-2002-40428, light that has passed through a polarizing plate on an entry side is converted into circular polarized light prior to entering into a liquid-crystal layer, and is then converted into linearly-polarized light after passing through the liquid-crystal layer, whereupon the light enters into a polarizing plate on the exit side. According to this technique, it is possible to suppress the occurrence of display problems caused by orientation problems in the liquid-crystal layer; however, because a ¼ wave plate has a strong wavelength dependence, it is possible for the contrast ratio to drop due to light dropout, depending on the spectrum of the light that enters into the liquid-crystal layer. Meanwhile, with the technique disclosed in JP-A-2008-70690, by adjusting the optical axis direction and phase differences of the respective layers in a stacked wave plate, the stacked wave plate functions as a ¼ wave plate in a blue band, a green band, and a red band.

The technique according to JP-A-2008-70690 makes it possible to convert multiple lights having different wavelengths into circular polarized light using a single stacked wave plate. However, even if such a stacked wave plate is used, it is nevertheless difficult to convert the respective lights into circular polarized light at a high level of precision, and there is still a risk that light dropout will cause a drop in the contrast ratio. In addition, even if an attempt is made to convert the respective lights into circular polarized light at a high level of precision, it is necessary to carry out highly-precise processes when manufacturing the stacked wave plate, which carries the risk that the device costs will be increased.

### SUMMARY

It is an advantage of some aspects of the invention to provide a projector that is capable of effectively suppressing display problems caused by orientation problems in a liquid-crystal layer and capable of suppressing a drop in the contrast ratio due to light dropouts.

A projector according to a first aspect of the invention includes: a plurality of illumination systems, each of which is configured so as to include a solid-state light source, that emit light of different wavelengths; a liquid-crystal panel that modulates the light emitted from the plurality of illumination systems; wavelength plates, provided one-to-one for the respective illumination systems in the respective optical paths between each of the plurality of illumination systems and the liquid-crystal panel, whose retardations are set to ¼ the central wavelength of the light emitted from the corresponding illumination systems; and a projection optical system that projects the light modulated by the liquid-crystal panel.

With the projector according to the first aspect, the wavelength plates are provided in the respective optical paths between the plurality of illumination systems and the liquid-crystal panel so as to correspond one-to-one to the illumination systems, and the retardations thereof are set to ¼ the central wavelength of the light emitted from the illumination systems that correspond thereto; therefore, the light that enters into the liquid-crystal panel can be converted into circular polarized light with a high degree of precision. As a result, it is possible to suppress the occurrence of display problems caused by orientation problems in the liquid-crystal panel. Furthermore, the pre-tilt angle relative to the thickness direction of the liquid-crystal layer in the liquid-crystal panel can be reduced, which makes it possible to improve the contrast ratio. In addition, because the respective illumination systems are configured so as to include solid-state light sources, the spectral widths of the light emitted from the illumination systems are narrowed, and the retardations are set individually for each of the wavelength plates that correspond to respective illumination systems; therefore, the light that enters into the liquid-crystal panel is suppressed from taking on an undesired polarization state due to the wavelength dependences of the wavelength plates. Accordingly, it is possible to control the polarization state of the light emitted from the liquid-crystal panel with a high degree of precision, which in turn makes it possible to suppress a drop in the contrast ratio caused by light dropouts. Thus, as described thus far, the projector according to the first aspect is capable of suppressing the occurrence of display problems caused by orientation problems and a drop in the contrast ratio caused by light dropouts, and is therefore capable of displaying a high-quality image.

It is preferable that the projector according to the first aspect further include polarizing plates provided in the respective optical paths between each of the plurality of illumination systems and the liquid-crystal panel, and the wavelength plates be disposed in the optical paths between the polarizing plates and the liquid-crystal panel.

As a result, the linearly-polarized light that has passed through the polarizing plates enters into the wavelength plates, which makes it possible to control the polarization state of the light emitted from the wavelength plates with a high degree of precision; this in turn makes it possible to significantly suppress the occurrence of display problems and a drop in the contrast ratio.

In the projector according to the first aspect, it is preferable that a plurality of liquid-crystal panels be provided one-to-one corresponding to the respective illumination systems, and each liquid-crystal panel be configured as a transmissive type liquid-crystal panel, and the projector further include: a combination unit that combines the light modulated by the plurality of liquid-crystal panels; an exit-side wavelength plate, disposed in the optical path between the liquid-crystal panels and the combination unit, whose retardation is set to the same value as the wavelength plate that corresponds to the liquid-crystal panel; and an exit-side polarizing plate disposed in the optical path between the exit-side wavelength plate and the combination unit, and the projection optical system project the light combined by the combination unit.

Accordingly, transmissive type liquid-crystal panels are provided one-to-one for the respective illumination systems, and the exit-side wavelength plate, whose retardation is set to the same value as that of the wavelength plate on the entry side of the light relative to the liquid-crystal panels, is disposed in the optical path between the liquid-crystal panels and the combination unit; therefore, the light emitted from the respective liquid-crystal panels can be converted into linearly-polarized light with a high degree of precision. This linearly-polarized light enters into the exit-side polarization plate disposed in the optical path between the exit-side wavelength plate and the combination unit, and it is therefore possible to significantly suppress a drop in the contrast ratio caused by light dropouts.

It is preferable that the projector according to the first aspect further include an optical path adjustment unit that adjusts the optical paths between the plurality of wavelength plates and the liquid-crystal panel so that the optical paths of the light that enters into the liquid-crystal panel having traversed the plurality of wavelength plates provided in correspondence to the plurality of illumination systems match; the plurality of illumination systems emit the respective lights alternately in time sequence, and the liquid-crystal panel alternately modulate the respective lights emitted from the plurality of illumination systems in time sequence.

Accordingly, the liquid-crystal panel alternately modulates the respective lights emitted from the plurality of illumination systems in time sequence; as a result, the number of liquid-crystal panels can be reduced beyond the number of illumination systems, which in turn makes it possible to reduce the cost of the device.

In the projector according to the first aspect, it is preferable that the liquid-crystal panel be configured of a transmissive type liquid-crystal panel, and the projector further include: an exit-side wavelength plate, provided in the optical path between the liquid-crystal panel and the projection optical system, whose retardation is set to ¼ of 530 nm or to ¼ an average wavelength obtained by averaging the central wavelengths of the respective lights emitted from the plurality of illumination systems; and an exit-side polarizing plate disposed in the optical path between the exit-side wavelength plate and the projection optical system.

In the projector according to the first aspect, it is preferable that the liquid-crystal panel have a pre-tilt angle of 8° relative to the thickness direction of a liquid-crystal layer.

The projector according to the first aspect as described above can suppress the occurrence of display problems caused by orientation problems even in the case where the pre-tilt angle relative to the thickness direction of the liquid-crystal layer in the liquid-crystal panel has been reduced. Accordingly, by setting the pre-tilt angle of the liquid-crystal layer to less than or equal to 8°, it is possible to improve the contrast ratio while also suppressing the occurrence of display problems caused by orientation problems.

In the projector according to the first aspect, it is preferable that an air gap be provided adjacent to the light-emitting surface of each wavelength plate into which light from the corresponding illumination system enters.

Accordingly, it is possible to adjust the positions of the wavelength plates with a high degree of precision, which in turn makes it possible to set the positional relationships between the slow axis or the fast axis of the wavelength plates relative to the other constituent elements with a high degree of precision; this makes it possible to significantly suppress the occurrence of display problems and a drop in the contrast ratio.

In the projector according to the first aspect, it is preferable that the solid-state light source be configured so as to include a laser diode.

Generally speaking, laser diodes emit light that has an extremely narrow spectral width, and thus the lights emitted from the respective illumination systems are less susceptible to the influence of the wavelength dependence of the wavelength plates; this makes it possible to significantly suppress the occurrence of display problems and a drop in the contrast ratio.

It is preferable that the projector according to the first aspect further include an optical compensation plate disposed in the optical path of light that enters into the liquid-crystal panel from the polarizing plate or in the optical path of the light that has been emitted from the liquid-crystal panel.

Accordingly, birefringence caused by the pre-tilt of the liquid-crystal panel can be canceled out by the optical compensation plate, which makes it possible to significantly suppress a drop in the contrast ratio caused by light dropouts that occur due to the birefringence resulting from the pre-tilt.

### BRIEF DESCRIPTION OF THE DRAWINGS

The invention will be described with reference to the accompanying drawings, wherein like numbers reference like elements.

FIG. 1 is a diagram illustrating the configuration of a projector according to a first embodiment.

FIG. 2 is a diagram illustrating the relationships, relative to an optical axis, of various constituent elements that configure a first image forming system according to the first embodiment.

FIG. 3 is a diagram illustrating the overall configuration of a liquid-crystal panel according to the first embodiment.

FIG. 4A is a diagram illustrating an original image; FIG. 4B is a diagram illustrating a display image according to a comparative example, and FIG. 4C is a diagram illustrating a display image according to a working example.

FIG. 5 is a diagram illustrating the configuration of a projector according to a second embodiment.

FIG. 6 is a diagram illustrating an example of operations performed by the projector according to the second embodiment.

### DESCRIPTION OF EXEMPLARY EMBODIMENTS

Hereinafter, embodiments of the invention will be described with reference to the drawings. The dimensions, scale, and so on of the structures in the diagrams used for the descriptions may differ from the actual dimensions, scale, and so on.

### First Embodiment

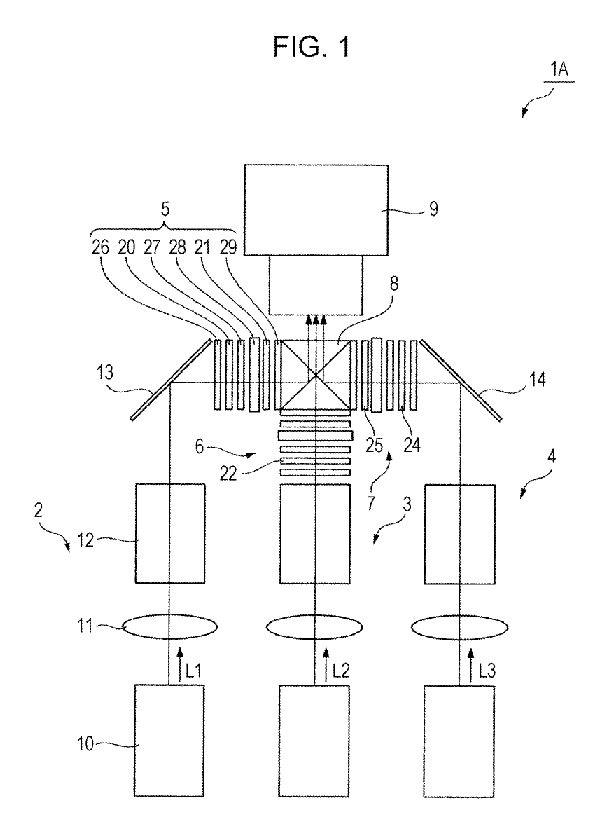

A first embodiment will now be described. FIG. 1 is a diagram illustrating the configuration of a projector according to the first embodiment. A projector 1A illustrated in FIG. 1 is capable of displaying, on a projection surface such as a screen, full-color images defined by image data based on image data supplied from a device external to the projector 1A such as a PC or a DVD player.

The projector 1A includes: three illumination systems 2 through 4 that emit light of different wavelengths; three image forming systems 5 through 7 that form images of different colors; a combination unit 8 that combines the images of the plurality of colors formed by the plurality of image forming systems 5 through 7; and a projection optical system 9 that projects the image (light) resulting from the combination performed by the combination unit 8.

In this embodiment, the first illumination system 2 is capable of emitting red light L1 (having a central wavelength of, for example, 630 nm), the second illumination system 3 is capable of emitting green light L2 (having a central wavelength of, for example, 530 nm), and the third illumination system 4 is capable of emitting blue light L3 (having a central wavelength of, for example, 440 nm).

Each of the three image forming systems 5 through 7 is provided so as to correspond one-to-one with one of the three illumination systems 2 through 4. A first image forming system 5 corresponds to the first illumination system 2, and is capable of forming a red image using the red light L1 emitted from the first illumination system 2. Likewise, the second image forming system 6 is capable of forming a green image using the green light L2 emitted from the second illumination system 3, whereas the third image forming system 7 is capable of forming a blue image using the blue light L3 emitted from the third illumination system 4.

The combination unit 8 is configured of a dichroic prism or the like. This dichroic prism has a structure in which a wavelength selection film having a property in which the red light L1 is reflected but the green light L2 and the blue light L3 are allowed to pass, and a wavelength selection film having a property in which the blue light L3 is reflected but the red light L1 and the green light L2 are allowed to pass, are provided orthogonal to each other. The lights L1 through L3 that are emitted from the three illumination systems 2 through 4 and pass through the three image forming systems 5 through 7 are allowed to pass or are reflected by the two types of wavelength selection surfaces in the combination unit 8, and thus advance in the same direction as a result; the lights are combined so as to overlap with each other on the projection surface. The lights L1 through L3 that overlap with each other result in light that overall represents a full-color image. The full-color image is displayed upon the projection surface by being formed on the projection surface by the projection optical system 9.

Next, the constituent elements of the projector 1A will be described in detail.

The first illumination system 2 includes a solid-state light source 10, a concentration lens 11, and a rod lens (also called a “rod integrator”) 12. The solid-state light source 10 includes a laser diode (LD) that is not shown. This laser diode has an active layer that emits light as the result of a current supplied from a driver (not shown), and a resonator capable of laser-oscillating the light emitted from the active layer. The solid-state light source 10 is capable of emitting laser light that is essentially linearly-polarized as the red light L1.

The rod lens 12 has a column shape that extends in a predetermined axial direction, and light that has entered from one end surface in the axial direction is repeatedly reflected therewithin and is then emitted from the other end surface. The rod lens 12 can uniformize the optical intensity distribution of the light that has passed therethrough. The concentration lens 11 concentrates the light L1 so that a spot of the light L1 emitted from the solid-state light source 10 falls within the one end surface of the rod lens 12 in the axial direction.

The second illumination system 3 and the third illumination system 4 are both configured so as to include solid-state light sources, concentration lenses, and rod lenses; and aside from the wavelengths of the lights emitted from the solid-state light sources being different, have the same configuration as the first illumination system 2. Note that a solid-state light source that, for example, includes a laser diode having an active layer that emits infrared light and a resonator, and a wavelength conversion element (for example, a PPLN) provided inside or outside of the resonator, can be given as an example of a solid-state light source capable of emitting laser light as the green light L2.

In this embodiment, the light L1 emitted from the first illumination system 2 is reflected by a reflective mirror 13, and then enters into the first image forming system 5. The light L2 emitted from the second illumination system 3 enters into the second image forming system 6, whereas the light L3 emitted from the third illumination system 4 is reflected by a reflective mirror 14 and then enters into the third image forming system 7.

The three image forming systems 5 through 7 each include a transmissive type liquid-crystal panel, a wavelength plate disposed on the light entry side of the liquid-crystal panel (this will be called “entry-side wavelength plate” hereinafter), and an exit-side wavelength plate disposed on the light exit side of the liquid-crystal panel. The entry-side wavelength plates in the image forming systems have a retardation that is set to ¼ the central wavelength of the light emitted from the corresponding illumination system. The exit-side wavelength plates in the image forming systems have a retardation that is set to the same value as that in the entry-side wavelength plate of that image forming system. “Retardation” refers to a value obtained by multiplying the thickness of the wavelength plate by the difference between the refractive index of the direction parallel to the slow axis and the refractive index of the direction parallel to the fast axis.

Specifically, an entry-side wavelength plate 20 and an exit-side wavelength plate 21 of the first image forming system 5 have a retardation that is set to ¼ the central wavelength (630 nm) of the red light L1 emitted from the first illumination system 2 (that is, approximately 158 nm). Likewise, an entry-side wavelength plate 22 and an exit-side wavelength plate 23 of the second image forming system 6 have a retardation that is set to ¼ the central wavelength (530 nm) of the green light L2 emitted from the second illumination system 3 (that is, approximately 132 nm). Furthermore, an entry-side wavelength plate 24 and an exit-side wavelength plate 25 of the third image forming system 7 have a retardation that is set to ¼ the central wavelength (440 nm) of the blue light L3 emitted from the third illumination system 4 (that is, approximately 110 nm). In this manner, the retardation of the entry-side wavelength plates is different among the three image forming systems 5 through 7.

In addition to the entry-side wavelength plate and the exit-side wavelength plate, each of the three image forming systems 5 through 7 according to this embodiment includes an entry-side polarizing plate, an optical compensation plate, a liquid-crystal panel, and an exit-side polarizing plate. Aside from the retardation of the entry-side wavelength plates being different among the three image forming systems 5 through 7, and the retardation of the exit-side wavelength plates being different among the three image forming systems 5 through 7, the three image forming systems 5 through 7 have the same configuration. Here, the configuration of the first image forming system 5 will be described as a representative example.

The red light L1 that has entered into the first image forming system 5 from the first illumination system 2 passes through an entry-side polarizing plate 26 and enters into the entry-side wavelength plate 20, and is converted into circular polarized light by the entry-side wavelength plate 20. The circular polarized light emitted from the entry-side polarizing plate 26 passes through an optical compensation plate 27 and enters into a liquid-crystal panel 28, and is phase-modulated by the liquid-crystal panel 28. The light L1 that has been modulated by the liquid-crystal panel 28 enters the exit-side wavelength plate 21, is converted into linearly-polarized light, and then enters into an exit-side polarizing plate 29.

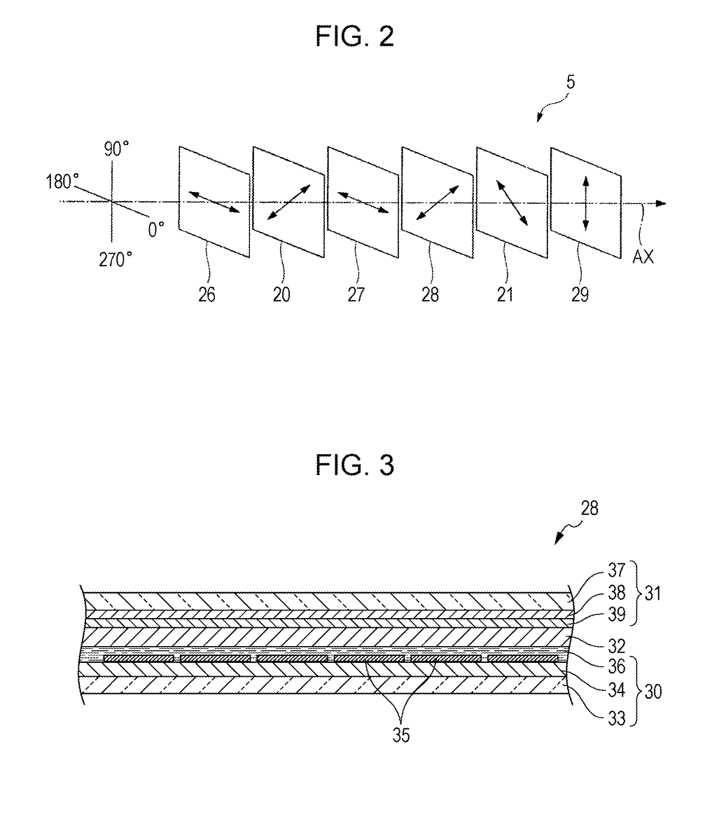

FIG. 2 is a diagram illustrating the relationships, relative to an optical axis, of various constituent elements that configure the first image forming system according to the first embodiment. The letters AX in FIG. 2 indicate an optical axis (that is, the center of an optical path) from the first illumination system 2 to the combination unit 8.

The entry-side polarizing plate 26 and the exit-side polarizing plate 29 are each polarizing plate having a property in which linearly-polarized light parallel to a passage axis passes therethrough. The passage axis of the entry-side polarizing plate 26 is set to a passage axis that allows almost all of the light L1 (that is primarily linearly-polarized light) emitted from the first illumination system 2 to pass therethrough. The passage axis of the entry-side polarizing plate 26 is, when viewed from the optical axis AX, orthogonal to the passage axis of the exit-side polarizing plate 29.

The entry-side wavelength plate 20 and the exit-side wavelength plate 21 are configured, for example, of normal wavelength plates. The slow axis of the entry-side wavelength plate 20 is, when viewed from the optical axis AX, parallel to a direction in which the passage axis of the entry-side polarizing plate 26 has been rotated 45° counterclockwise. The slow axis of the exit-side wavelength plate 21 is, when viewed from the optical axis AX, parallel to a direction in which the passage axis of the entry-side polarizing plate 26 has been rotated 135° counterclockwise, and is orthogonal to the slow axis of the entry-side wavelength plate 20.

The entry-side wavelength plate 20 and the exit-side wavelength plate 21 according to this embodiment both have their light entrance surfaces, into which the light L1 emitted from the first illumination system 2 enters, adjacent to an air gap (an air layer), and both have their light-emitting surfaces, from which the light L1 is emitted, adjacent to an air gap. In other words, the entry-side wavelength plate 20 is attached so that there is an air gap between the entry-side wavelength plate 20 and the entry-side polarizing plate 26, and so that there is an air gap between the entry-side wavelength plate 20 and the optical compensation plate 27. Likewise, the exit-side wavelength plate 21 is attached so that there is an air gap between the exit-side wavelength plate 21 and the liquid-crystal panel 28, and so that there is an air gap between the exit-side wavelength plate 21 and the exit-side polarizing plate 29.

FIG. 3 is a diagram illustrating the overall configuration of the liquid-crystal panel. FIG. 3 schematically illustrates the cross-sectional structure of the liquid-crystal panel as viewed parallel to the thickness direction of a liquid-crystal layer.

The liquid-crystal panel 28 according to this embodiment includes an element substrate 30, an opposing substrate 31 disposed opposite to the element substrate 30, and a liquid-crystal layer 32 that is interposed between the element substrate 30 and the opposing substrate 31. The liquid-crystal panel 28 (see FIG. 2) is disposed so that the slow axis of the liquid-crystal layer 32 is parallel to the slow axis of the entry-side wavelength plate 20. In the case where a transmissive type liquid-crystal panel is used as the liquid-crystal panel 28, the respective constituent elements of the element substrate 30 and the opposing substrate 31 that are disposed along the optical path are formed of a material that is light-transmissive.

The element substrate 30 includes a first substrate 33, an element layer 34 formed above the first substrate 33, a plurality of pixel electrodes 35 formed above the element layer 34, and a first orientation layer 36 formed above the pixel electrodes 35. The opposing substrate 31 includes a second substrate 37, a common electrode 38 formed above the second substrate 37, and a second orientation layer 39 formed above the common electrode 38. The element substrate 30 is affixed to the opposing substrate 31, with the side on which the pixel electrodes 35 are formed relative to the first substrate 33 facing toward the side of the opposing substrate 31 on which the common electrode 38 is formed relative to the second substrate 37.

The first substrate 33 of the element substrate 30 and the second substrate 37 of the opposing substrate 31 are, for example, glass substrates, silicon substrates, resin substrates, or the like. The element layer 34 includes various types of wires such as scanning lines and data lines, switching elements for switching electrical signals to the pixel electrodes 35, and an insulating film such as an inter-layer insulating film, a passivation film, or the like.

The pixel electrodes 35 and the common electrode 38 are disposed so that the liquid-crystal layer 32 is interposed therebetween. The pixel electrodes 35 and the common electrode 38 are capable of applying an electrical field to the liquid-crystal layer 32 at each region (pixel) where a pixel electrode 35 overlaps with the liquid-crystal layer 32 when viewed from the thickness direction thereof. The pixel electrodes 35 and the common electrode 38 are formed of a conductive material that is light-transmissive, such as indium tin oxide (ITO).

The first orientation layer 36 and the second orientation layer 39 are inorganic orientation layers formed by depositing an inorganic material such as silicon oxide using an oblique deposition method such as oblique vapor deposition, oblique sputtering, or the like. Using an inorganic orientation layer makes it possible to increase the light resistance more than that when using an organic orientation layer. The first orientation layer 36 and the second orientation layer 39 are capable of controlling the orientation of the liquid-crystal layer 32 so that the liquid-crystal layer 32 achieves a predetermined degree of pre-tilt.

The liquid-crystal layer 32 according to this embodiment is a vertically-aligned (VA) mode liquid-crystal layer configured of a liquid-crystal material having negative dielectric anisotropy. In the liquid-crystal layer 32, the azimuth angle of the liquid-crystal particles changes as a result of an electrical field applied by the pixel electrodes 35 and the common electrode 38, thus changing the birefringence. Through this, the liquid-crystal layer 32 can change the polarization state of the light that passes through the pixels on a pixel-by-pixel basis.

The liquid-crystal layer 32 according to this embodiment is set, by the first orientation layer 36 and the second orientation layer 39, to a pre-tilt angle of 5° relative to the thickness direction of the liquid-crystal layer 32. The pre-tilt angle may be greater than or equal to 0° and less than or equal to 8°, greater than or equal to 0° and less than or equal to 6°, or greater than or equal to 0° and less than or equal to 4°. The aforementioned optical compensation plate 27 is configured of, for example, a negative C plate, and is provided so as to cancel out birefringence caused by the pre-tilt of the liquid-crystal layer 32.

Here, a system through which an image is formed by the first image forming system 5 will be described, focusing on a single pixel. When an electrical field is not being applied to the liquid-crystal layer 32, the light that passes through the liquid-crystal layer 32 and the optical compensation plate 27 experiences almost no change in the phase difference between the polarized component parallel to the slow axis and the polarized component parallel to the fast axis, and is emitted from the liquid-crystal layer 32 as such. This light is converted by the exit-side wavelength plate 21 into linearly-polarized light that is orthogonal to the passage axis of the exit-side polarizing plate 29, and almost all of that light is absorbed by the exit-side polarizing plate 29 (a dark display). On the other hand, when an electrical field is being applied to the liquid-crystal layer 32, the light that passes through the liquid-crystal layer 32 experiences an additional phase difference equivalent to ½ the wavelength to the phase difference between the polarized component parallel to the slow axis and the polarized component parallel to the fast axis. This light is converted by the exit-side wavelength plate 21 into linearly-polarized light that is essentially parallel to the passage axis of the exit-side polarizing plate 29, and almost all of this light passes through the exit-side polarizing plate 29 (a bright display). In this manner, the first image forming system 5 can control the brightness of the pixels on a pixel-by-pixel basis, and therefore can form an image configured of a plurality of pixels.

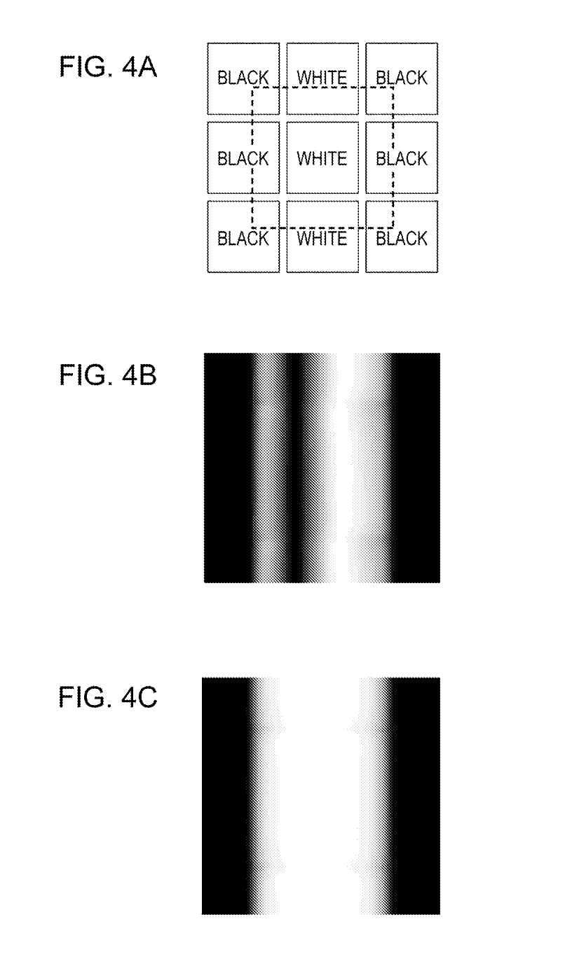

Next, a display image according to a comparative example and a display image according to a working example will be described. FIG. 4A is a diagram illustrating an original image; FIG. 4B is a diagram illustrating a display image according to a comparative example, and FIG. 4C is a diagram illustrating a display image according to a working example.

The original image illustrated in FIG. 4A includes dark portions in which pixels displaying black are arranged in the vertical scanning direction and bright portions in which pixels displaying white are arranged in the vertical scanning direction, and the dark portions and bright portions are arranged in the horizontal scanning direction. The display image according to the comparative example illustrated in FIG. 4B is an image that is displayed when the image data illustrated in the aforementioned original image is supplied to a projector according to the comparative example. The projector according to the comparative example is a projector capable of projecting a full-color image by dividing white light from a light source configured of an ultra-high-pressure mercury (UHP) lamp into the three RGB colors and combining single-color images formed from the respective colors of light.

In typical projectors, such as the projector illustrated in the comparative example, the liquid-crystal panel used to form the images has a smaller pixel size than a liquid-crystal panel used in a direct-view display device. Accordingly, the liquid-crystal layer for a given pixel is susceptible to the influence of the electrical fields applied to other adjacent pixels, and thus orientation problems, in which the liquid-crystal particles fall toward a different direction than the intended direction, can occur.

The display image according to the comparative example illustrated in FIG. 4B illustrates the occurrence of a display problem, in which part of the bright portion displays black, caused by orientation problems in the liquid-crystal layer. Such an orientation problem in the liquid-crystal layer is more likely to occur as the pre-tilt angle relative to the thickness direction of the liquid-crystal layer is set to a lower value within a range that is less than or equal to 8°. On the other hand, although it is less likely for orientation problems to occur in the liquid-crystal layer in the case where the pre-tilt angle is set to a value that is greater than 8°, it is more likely for light dropout to occur due to birefringence caused by the pre-tilt as the pre-tilt angle grows; this makes it easy for the contrast ratio to drop.

With the projector 1A according to this embodiment, however, the light that passes through the entry-side wavelength plate 20 and enters into the liquid-crystal panel 28 is circular polarized light, and therefore, as shown in FIG. 4C, it is difficult for display problems caused by orientation problems to occur.

Furthermore, with the projector 1A, the retardations of the entry-side wavelength plates corresponding to the respective illumination systems are set in accordance with the wavelengths of the light emitted from those respective illumination systems, and therefore the light that enters into the liquid-crystal panel can be suppressed from taking on an undesired polarization state due to the wavelength dependence of the entry-side wavelength plates. Accordingly, it is possible to control the polarization state of the light emitted from the liquid-crystal panel with a high degree of precision, which in turn makes it possible to suppress a drop in the contrast ratio caused by light dropouts. Accordingly, the occurrence of display problems and a drop in the contrast ratio is suppressed for all of the images formed by the three image forming systems 5 through 7, which makes it possible to display a high-quality full-color image.

Furthermore, because the occurrence of display problems caused by orientation problems in the liquid-crystal layer 32 can be suppressed, it is possible to set the pre-tilt angle to a low angle (for example, less than or equal to 8°); as a result, the birefringence caused by the pre-tilt is reduced, which makes it possible to suppress a drop in the contrast ratio caused by light dropouts. For example, while the contrast ratio of the display image according to the comparative example illustrated in FIG. 4B is 21,000:1, the contrast ratio of the display image according to the working example illustrated in FIG. 4C is 35,000:1.

In addition, because linearly-polarized light that has passed through the entry-side polarizing plate enters into the exit-side wavelength plate in each of the image forming systems, it is possible to control the polarization state of the light that enters into the liquid-crystal layer from the exit-side wavelength plate with a high degree of precision, which in turn makes it possible to significantly suppress the occurrence of display problems and a drop in the contrast ratio.

In addition, because an exit-side wavelength plate that has the same retardation as the entry-side wavelength plate is disposed in each optical path between the corresponding liquid-crystal panels and the combination unit, it is possible to convert the light emitted from the liquid-crystal panels into linearly-polarized light with a high degree of precision. Accordingly, it is possible to suppress the occurrence of light dropouts in the exit-side polarizing plate, which in turn makes it possible to significantly suppress a drop in the contrast ratio.

In addition, the entry-side wavelength plate and the exit-side wavelength plate are each provided with an air gap adjacent to the light entrance surface thereof and are each provided with an air gap adjacent to the light-emitting surface thereof, and it is therefore possible, for example, to adjust the relative positions to the other adjacent constituent elements with a high degree of precision when assembling the projector. Accordingly, for example, the relative relationship between the direction of the slow axis of the entry-side wavelength plate and the optical axial direction of the other constituent elements can be set with a high degree of precision, which in turn makes it possible to control the polarization state of the light in each of the image forming systems with a high degree of precision. In addition, the light emitted from the entry-side wavelength plate and reflected by the liquid-crystal panel once again enters into the entry-side wavelength plate and turns into linearly-polarized light; this light enters into the entry-side polarizing plate and is absorbed, and is thus unlikely to become stray light.

In addition, the light emitted from the respective illumination systems is light emitted from solid-state light sources, and therefore the spectral width is narrower than that of the respective colors of light resulting from color-dividing the light emitted from an ultra-high-pressure mercury lamp. Accordingly, the light emitted from the illumination systems is less susceptible to the influence of the wavelength dependence of the entry-side wavelength plates, and thus the polarization state of the light that enters into the liquid-crystal panels can be controlled with a high degree of precision. In particular, in this embodiment, the light emitted from the solid-state light sources is laser light, and thus the spectral width thereof is significantly narrower; this makes it possible to control the polarization state of the light that enters into the liquid-crystal panel with an extremely high level of precision.

### Second Embodiment

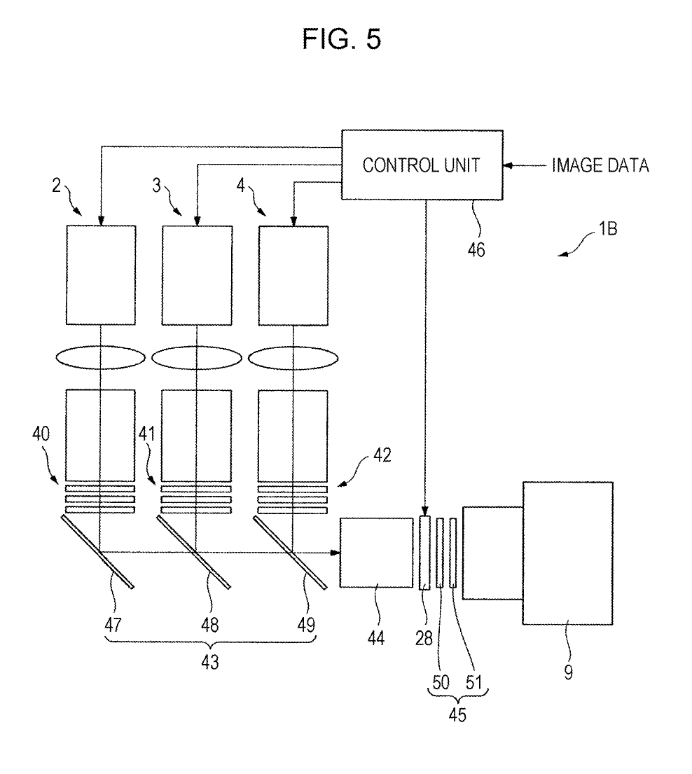

A second embodiment will now be described. In the following descriptions, constituent elements that are the same as those described in the first embodiment will be given the same reference numerals, and descriptions thereof will be omitted. FIG. 5 is a diagram illustrating the configuration of a projector according to the second embodiment.

A projector 1B illustrated in FIG. 5 is a projector that is capable of displaying a full-color image using the field-sequential scheme. The projector 1B includes: entry-side polarization adjustment portions 40 through 42 that are provided one-to-one for each of the three illumination systems 2 through 4; an optical path adjustment portion 43 that adjusts the optical path between the entry-side polarization adjustment portions 40 through 42 and the liquid-crystal panel 28 so that the respective optical paths of the lights emitted from the entry-side polarization adjustment portions 40 through 42 match when those lights enter into the liquid-crystal panel 28; a parallelizing optical system 44 disposed in the optical path between the optical path adjustment portion 43 and the liquid-crystal panel 28; an exit-side polarization adjustment portion 45 disposed in the optical path between the liquid-crystal panel 28 and the projection optical system 9; and a control unit 46.

Each of the entry-side polarization adjustment portions 40 through 42 has the same configuration as the optical systems between the illumination systems and the liquid-crystal panels in the first embodiment, and therefore includes an entry-side polarizing plate, an entry-side wavelength plate, and an optical compensation plate. The first entry-side polarization adjustment portion 40 corresponds to the first illumination system 2, the second entry-side polarization adjustment portion 41 corresponds to the second illumination system 3, and the third entry-side polarization adjustment portion 42 corresponds to the third illumination system 4. Each entry-side wavelength plate in the entry-side polarization adjustment portions 40 through 42 is, as in the first embodiment, set to a retardation that is ¼ the central wavelength of the light that is emitted from its corresponding illumination system.

The optical path adjustment portion 43 includes a reflective mirror 47, a first dichroic mirror 48, and a second dichroic mirror 49. The reflective mirror 47 is disposed at a position into which the red light L1 that has been emitted from the first illumination system 2 and that has passed through the first entry-side polarization adjustment portion 40 enters. The reflective mirror 47 has a property of reflecting the red light L1.

The first dichroic mirror 48 is disposed at a position into which the red light L1 reflected by the reflective mirror 47 and the green light L2 that has been emitted from the second illumination system 3 and that has passed through the second entry-side polarization adjustment portion 41 enters. The first dichroic mirror 48 has a property of allowing the red light L1 to pass but reflecting the green light L2. The first dichroic mirror 48 is disposed so that the optical path of the green light L2 reflected by the first dichroic mirror 48 and the optical path of the red light L1 that has passed through the first dichroic mirror 48 essentially match.

The second dichroic mirror 49 is disposed in a position into which the red light L1 and the green light L2 that have passed through the first dichroic mirror 48 and the blue light L3 that has been emitted from the third illumination system 4 and that has passed through the third entry-side polarization adjustment portion 42 enters. The second dichroic mirror 49 has a property of allowing the red light L1 and the green light L2 to pass but reflecting the blue light L3. The second dichroic mirror 49 is disposed so that the optical path of the blue light L3 reflected by the second dichroic mirror 49 and the optical path of the red light L1 and the green light L2 that have passed through the second dichroic mirror 49 essentially match.

The parallelizing optical system 44 is configured of one, or two or more, lenses, such as field lenses. The parallelizing optical system 44 can parallelize the light that has passed through the optical path adjustment portion 43 and that enters into the liquid-crystal panel 28.

The exit-side polarization adjustment portion 45 includes an exit-side wavelength plate 50 disposed in the optical path between the liquid-crystal panel 28 and the projection optical system 9, and an exit-side polarizing plate 51 disposed in the optical path between the exit-side wavelength plate 50 and the projection optical system 9. The exit-side polarizing plate 51 has a property of allowing linearly-polarized light parallel to the passage axis to pass. The exit-side wavelength plate 50 as its retardation set to ¼ a specific wavelength selected from the entire wavelength range of the light that enters from the liquid-crystal panel 28. The stated specific wavelength is selected taking into consideration, for example, the contrast ratio and color shade (color reproducibility) of the image when the image is actually displayed, the degree to which display problems can be recognized, and so on. In this embodiment, the stated specific wavelength is set to the central wavelength (here, 530 nm) of the green light L2, whose light amount contributes the most to the white balance from among the lights L1 through L3 emitted from the three illumination systems. This makes it possible to effectively improve the contrast ratio. However, the stated specific wavelength may be the average value of the central wavelength of the respective lights L1 through L3 (for example, (440+530+630)/3=533).

The control unit 46 controls the lighting/extinguishing of the solid-state light sources in the three illumination systems 2 through 4 based on the image data that represents the image to be displayed. The three illumination systems 2 through 4 are controlled by the control unit 46, and the respective lights can be emitted alternately in time sequence. The control unit 46 controls the liquid-crystal panel 28 in synchronization with the timing at which the lights are emitted from the respective illumination systems so that images of the respective colors are formed by the lights of the respective colors emitted from the illumination systems in time sequence.

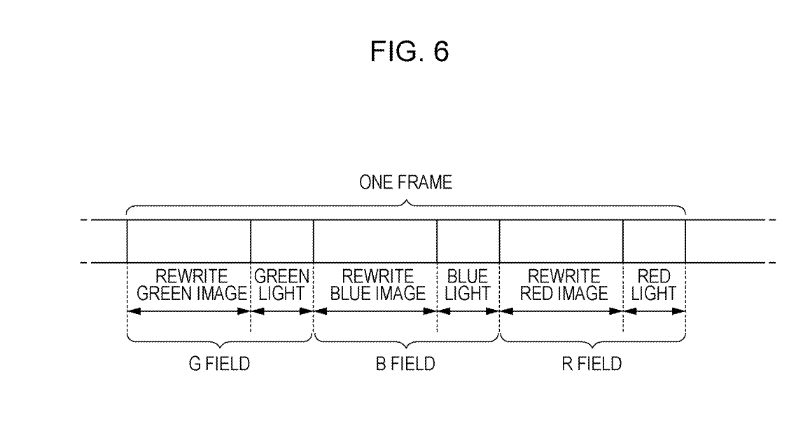

FIG. 6 is a diagram illustrating an example of operations performed by a projector.

The interval indicated as “1 frame” in FIG. 6 includes a G field for displaying a green image, a B field for displaying a blue image, and an R field for displaying a red image.

In the G field interval, the control unit 46 controls the liquid-crystal panel 28 so that the image that can be formed by the liquid-crystal panel 28 is rewritten with a green image, and then causes the solid-state light source in the second illumination system 3 to light. Through this, the green light L2 emitted from the second illumination system 3 becomes light that is modulated by the liquid-crystal panel 28 and expresses a green image; this light is then projected by the projection optical system 9. The control unit 46 begins the B field after the solid-state light source of the second illumination system 3 has been extinguished following the end of the G field.

In the B field interval, the control unit 46 controls the liquid-crystal panel 28 so that the image is rewritten to a blue image, and then causes the solid-state light source in the third illumination system 4 to light; then, the solid-state light source in the third illumination system 4 is extinguished following the end of the B field.

In the R field interval, the control unit 46 controls the liquid-crystal panel 28 so that the image is rewritten to a red image, and then causes the solid-state light source in the first illumination system 2 to light; then, the solid-state light source in the first illumination system 2 is extinguished following the end of the R field.

In this manner, images of the respective colors are projected in time sequence, and the images of the plurality of colors are viewed by a viewer as being integrated with time, resulting in the image being seen as a full-color image. The control unit 46 begins the G field of the next frame after the R field of the previous frame has ended.

With the projector 1B according to the second embodiment, the occurrence of display problems and a drop in the contrast ratio is suppressed for the same reasons as in the first embodiment, which makes it possible to display a high-quality full-color image. Furthermore, because the respective lights emitted from the three illumination systems are modulated by the same liquid-crystal panel 28, the number of liquid-crystal panels can be reduced, which makes it possible to reduce the cost of the apparatus.

It should be noted that the technical scope of the invention is not intended to be limited to the embodiments described thus far. Many variations are possible within the stated scope and without departing from the essential spirit of the invention.

For example, the solid-state light sources in the respective illumination systems may be configured of light-emitting diodes that emit light without laser oscillation. The liquid-crystal panels in the respective image forming systems may be reflective-type liquid-crystal panels. In this case, the entry-side wavelength plate can also be caused to function as an exit-side wavelength plate, and it is thus possible to omit the exit-side wavelength plate. At least one of the entry-side polarizing plate and the exit-side polarizing plate may be provided so as to make contact with another member, and the light entrance surface or light-emitting surface may be affixed to another member and thus essentially integrated therewith. The optical compensation plate may be disposed on the light exit side relative to the liquid-crystal panel, or may be omitted entirely. Instead of a dichroic prism, a plurality of dichroic mirrors may be employed as the combination unit.

The entire disclosure of Japanese Patent Application No. 2011-012831, filed Jan. 25, 2011 is expressly incorporated by reference herein.

What is claimed is:

1. A projector comprising:
a plurality of illumination systems, each of which is configured so as to include a solid-state light source, that emit light of different wavelengths;
a liquid-crystal panel that modulates the light emitted from the plurality of illumination systems;
wavelength plates, provided one-to-one for the respective illumination systems in the respective optical paths between each of the plurality of illumination systems and the liquid-crystal panel, whose retardations are set to ¼ the central wavelength of the light emitted from the corresponding illumination systems; and
a projection optical system that projects the light modulated by the liquid-crystal panel.

2. The projector according to claim 1, further comprising:
polarizing plates provided in the respective optical paths between each of the plurality of illumination systems and the liquid-crystal panel,
wherein the wavelength plates are disposed in the optical paths between the polarizing plates and the liquid-crystal panel.

3. The projector according to claim 2,
wherein a plurality of liquid-crystal panels are provided one-to-one corresponding to the respective illumination systems, and each liquid-crystal panel is configured as a transmissive type liquid-crystal panel, and
the projector further comprises:
a combination unit that combines the light modulated by the plurality of liquid-crystal panels;
an exit-side wavelength plate, disposed in the optical path between the liquid-crystal panels and the combination unit, whose retardation is set to the same value as the wavelength plate that corresponds to the liquid-crystal panel; and
an exit-side polarizing plate disposed in the optical path between the exit-side wavelength plate and the combination unit,
wherein the projection optical system projects the light combined by the combination unit.

4. The projector according to claim 2, further comprising:
an optical path adjustment unit that adjusts the optical paths between the plurality of wavelength plates and the liquid-crystal panel so that the optical paths of the light that enters into the liquid-crystal panel having traversed the plurality of wavelength plates provided in correspondence to the plurality of illumination systems match,
wherein the plurality of illumination systems emit the respective lights alternately in time sequence, and the liquid-crystal panel alternately modulates the respective lights emitted from the plurality of illumination systems in time sequence.

5. The projector according to claim 4,
wherein the liquid-crystal panel is configured of a transmissive type liquid-crystal panel, and
the projector further comprises:
an exit-side wavelength plate, provided in the optical path between the liquid-crystal panel and the projection optical system, whose retardation is set to ¼ of 530 nm or to ¼ an average wavelength obtained by averaging the central wavelengths of the respective lights emitted from the plurality of illumination systems; and
an exit-side polarizing plate disposed in the optical path between the exit-side wavelength plate and the projection optical system.

6. The projector according to claim 1, wherein the liquid-crystal panel has a pre-tilt angle of 8° relative to the thickness direction of a liquid-crystal layer.

7. The projector according to claim 1, wherein an air gap is provided adjacent to the light-emitting surface of each wavelength plate into which light from the corresponding illumination system enters.

8. The projector according to claim 1, wherein the solid-state light source is configured so as to include a laser diode.

9. The projector according to claim 1, further comprising an optical compensation plate disposed in the optical path of light that enters into the liquid-crystal panel from the polarizing plate or in the optical path of the light that has been emitted from the liquid-crystal panel.
